(19) United States
(12) Patent Application Publication
(10) Pub. No.: US 2014/0020784 A1
(43) Pub. Date: Jan. 23, 2014

(54) PROCESS FOR THE CONTINUOUS PRODUCTION OF FOAMS IN PIPES

(71) Applicant: BASF SE, Ludwigshafen (DE)

(72) Inventors: Christof GRIESER-SCHMITZ, Osnabrueck (DE); Carsten Ellersiek, Lengerich (DE)

(21) Appl. No.: 13/920,356

(22) Filed: Jun. 18, 2013

Related U.S. Application Data
(60) Provisional application No. 61/672,308, filed on Jul. 17, 2012.

(51) Int. Cl. B29C 44/32; F16L 9/12

(52) U.S. Cl. CPC B29C 44/32; F16L 9/121
USPC 138/146; 264/45.8; 425/110

(57) ABSTRACT

The present invention relates to a continuous process for producing an insulated pipe comprising at least one medium pipe, an outer pipe, a layer of at least one polyurethane between the at least one medium pipe and outer pipe and a film tube between the at least one polyurethane and the outer pipe, which comprises at least the steps (A) provision, in a jaw band, of at least one medium pipe and a film tube formed continuously from a film, where the at least one medium pipe is arranged within the film tube in such a way that a gap is formed between the at least one medium pipe and the film tube, (B) introduction of a polyurethane system comprising at least one isocyanate component (a) and at least one polyol (b) into the gap, (C) foaming and allowing to cure of the polyurethane system and (D) application of a layer of at least one material to the film tube in order to form the outer pipe, where the polyurethane system has thixotropic properties.

The present invention relates to a continuous process for producing an insulated pipe comprising at least one medium pipe, an outer pipe, a layer of at least one polyurethane between the at least one medium pipe and outer pipe and a film tube between the at least one polyurethane and the outer pipe, which comprises at least the steps (A) provision, in a jaw band, of at least one medium pipe and a film tube formed continuously from a film, where the at least one medium pipe is arranged within the film tube in such a way that a gap is formed between the at least one medium pipe and the film tube, (B) introduction of a polyurethane system comprising at least one isocyanate component (a) and at least one polyol (b) into the gap, (C) foaming and allowing curing of the polyurethane system and (D) application of a layer of at least one material to the film tube in order to form the outer pipe, where the polyurethane system has thixotropic properties.

Pipes insulated by means of polyurethane foams are known in the prior art and are described, for example, in EP 1 141 613 B1, EPA 865 893, EP 1 777 051 B1, EP 1 595 904 A2, WO 00/39497, WO 01/18087 A1, EP 2 143 539 A1 and EP 1 428 848 B1. Insulated pipeline systems are assembled from individual pipe segments. Pipe lengths of 6 m, 12 m and 16 m are normally used for this purpose. Transition lengths required are manufactured specially or are cut to size from existing prefabricated goods. The individual pipe segments are welded together and insulated further in the region of the weld using existing muff technology. These muff connections bring about a greater damage potential than the pipes themselves. This difference results from the fact that the pipe lengths are produced under fixed, controllable conditions in production facilities. The muff connections are often produced under time pressure in all kinds of weather on the construction site. Influences such as temperature, soiling and moisture often influence the quality of the muff connections. Furthermore the number of muff connections represents a large cost factor in the installation of pipeline systems.

It is therefore desirable in the pipe processing industry to install as few as possible muff connections, based on the length of a line. This is achieved by use of longer individual pipe segments, although the production of these involves more demanding requirements and frequently leads to technical problems.

The majority of individual pipes are produced by means of the batchwise pipe-in-pipe production. In this process, the medium pipe, in general a steel pipe, is provided with star-shaped spacers which serve to center the inner pipe. The medium pipe is pushed into the outer pipe, in general a polyethylene pipe, so that an annular gap is formed between the two pipes.

This annular gap is filled with polyurethane foam, since this has excellent insulating properties. For this purpose, the slightly inclined double pipe is provided with closure caps which are equipped with static venting holes. The liquid reaction mixture is subsequently introduced into the annular gap by means of a polyurethane metering machine and flows downward in still liquid form in the annular gap until the reaction commences. From this point in time onwards, further distribution takes place by flow of the foam whose viscosity increases slowly, until the material has fully reacted.

EP 1 552 915 A2 discloses a process for producing insulated pipes, in which a polyurethane system comprising an isocyanate component and a polyol component having a low viscosity of less than 3000 mPas is introduced into the annular gap formed by the medium pipe and the outer pipe. After the introduction, the polyurethane system foams and cures at the same time.

EP 1 783 152 A2 likewise discloses a process for producing insulated pipes, in which a polyurethane system comprising an isocyanate component and a polyol component having a particularly low viscosity of less than 1300 mPas is introduced into the annular gap formed by the medium pipe and the outer pipe.

The documents EP 1 552 915 A2 and EP 1 783 152 A2 accordingly describe processes for producing insulated pipes, in which the problem of complete filling of the pipe before foaming and curing is solved by use of polyol components having a particularly low viscosity and thus good flowability. Although these processes are suitable for producing insulated pipes having diameters of greater than 355 mm and/or high foam densities, they display the known disadvantages of the batch process, e.g. labor-intensive and costly manufacture and relatively coarse cell structure. In addition, pipes manufactured in a batchwise manner have a relatively thick outer wall since it has to withstand the internal pressure generated during foaming. This causes an undesirable, increased usage of raw material and thus increased manufacturing costs.

Furthermore, a uniform foam density distribution of the foam is important for the quality of the pipes. However, this is not advantageous when using the processes known from the prior art. Usually, a lower foam density is obtained at the ends of the pipe and a higher foam density is obtained in the middle. The longer the pipe, the greater is the required foam density of the foam in the annular gap due to production reasons.

A disadvantage of the continuous process known from the prior art is that large amounts of polyurethane precursor mixture have to be introduced continuously into a moving double pipe made up of medium pipe and outer pipe formed by bringing together an elongated film. Since this mixture sometimes cannot be conveyed away quickly enough, the foam can run out of the pipe at the front.

Furthermore, the continuous processes known from the prior art have hitherto not made it advantageously possible to produce insulated pipes having a pipe diameter of more than 355 mm. In the production of insulated pipes having pipe diameters of greater than 355 mm using the processes known from the prior art, a large amount of polyurethane system has to be introduced into the film. Owing to the low viscosity of the polyurethane systems which are usually used, the polyurethane precursor mixture can, in processes of the prior art, drip out from the tube formed at the front and is thus no longer available for the actual production of the insulated pipes.

A further problem is to produce insulated pipes having high foam densities of the polyurethane foam by means of processes of the prior art. To achieve high foam densities, it is necessary to introduce a correspondingly large amount of polyurethane system into the tube formed from a film. Here too, the polyurethane system introduced can run out of the tube at the front and is thus no longer available to the actual process. The high foam densities are required for pipes which are used under water and there have to withstand the respective hydrostatic pressure.

It is at present difficult to produce insulated pipes which have two or more pipes for a medium and have a homogeneous foam structure over the entire pipe cross section by means of continuous processes of the prior art. The reason for this is, for example, the different path length of the ascending foam when two pipes for a medium are introduced during production.

It was an object of the present invention to provide a continuous process for producing insulated pipes, giving pipes which display a uniformly distributed foam density over the length of the pipe and a homogeneous foam structure over the pipe cross section, and also a small cell diameter of the polyurethane foam obtained and thus a low thermal conductivity. It is a further object of the present invention to provide a process which ensures that the polyurethane system introduced does not run out on one side of the pipe formed but remains completely in the gap between the at least one medium pipe and the film tube. It should also be possible to produce insulated pipes having large diameters and/or high foam densities of the insulating material continuously.

These objects are achieved according to the invention by a continuous process for producing an insulated pipe comprising at least one medium pipe, an outer pipe, a layer of at least one polyurethane between the at least one medium pipe and outer pipe and a film tube between the at least one polyurethane and the outer pipe, which comprises at least the steps:
(A) provision, in a jaw band, of at least one medium pipe and a film tube formed continuously from a film, where the at least one medium pipe is arranged within the film tube in such a way that a gap is formed between the at least one medium pipe and the film tube,
(B) introduction of a polyurethane system comprising at least one isocyanate component (a) and at least one polyol (b) into the gap,
(C) foaming and allowing curing of the polyurethane systems and
(D) application of a layer of at least one material to the film tube in order to form the outer pipe,
   where the polyurethane system has thixotropic properties.

The process of the invention is carried out continuously. This means, in particular, that each individual process step is carried out continuously.

The individual steps of the process of the invention will be described in detail below.

Step (A):

Step (A) of the process of the invention comprises provision, in a jaw band, of at least one medium pipe and a film tube formed continuously from a film, where the at least one medium pipe is arranged within the film tube in such a way that a gap is formed between the at least one medium pipe and the film tube.

According to the invention, at least one medium pipe, preferably one, two, three or four pipe(s) for a medium are present. According to the invention, particular preference is given to one or two pipe(s) for a medium, very particularly preferably two pipes for a medium, being present.

The at least one medium pipe, which according to the invention has a smaller diameter than the film tube and than the outer pipe formed in step (D) of the process of the invention, is arranged within the outer pipe in such a way that a gap is formed between the medium pipe and the outer pipe. The polyurethane system is introduced into this gap in step (B) according to the invention. Depending on the number of pipes for a medium which are present according to the invention, the gap formed has various shapes. In the particularly preferred case in which one medium pipe is present according to the invention, an annular gap is formed. In the further preferred embodiment in which two pipes for a medium are present according to the invention, a double annular gap is formed.

The at least one medium pipe used according to the invention is generally a steel pipe having an external diameter of, for example, from 1 to 70 cm, preferably from 4 to 70 cm, particularly preferably from 10 to 70 cm and very particularly preferably from 20 to 70 cm. If more than one medium pipe is present, these pipes can have identical or different external diameters.

Preference is given to all pipes for media present having the same diameter. The length of the at least one medium pipe is, for example, from 3 to 24 m, preferably from 6 to 16 m. More preferably, the at least one medium pipe is produced as rolled-up product having a length of, for example, from 50 to 1500 m.

In the continuous implementation of the process of the invention, the at least one medium pipe is provided, for example, in the form of rolled-up product. The at least one medium pipe can also be provided as straight lengths of pipe.

In step (A) of the process of the invention, at least one medium pipe and a film tube formed continuously from a film are provided in a jaw band.

For this purpose, an elongated film is taken off continuously from a roll and optionally joined together by methods known to those skilled in the art, for example welding, to form a film tube. This bringing together is, in a preferred embodiment of the process of the invention, carried out in the jaw band into which the at least one medium pipe is also continuously fed. The film is preferably fed in via a molded shoulder or film shoulder. Preference is given to a circular film tube being formed.

The film can comprise at least one layer of thermoplastic polymer which preferably has a diffusion-inhibiting effect in respect of the cell gases and oxygen. The film preferably additionally comprises at least one layer of metal, e.g. aluminum. Films which are suitable according to the invention are known from EP 0 960 723.

The film used according to the invention preferably has a width which allows formation of a corresponding film tube which has an internal diameter of generally from 6 to 90 cm, preferably from 12 to 90 cm, particularly preferably from 19 to 90 cm, very particularly preferably from 35 to 90 cm. This film is preferably provided as rolled-up product.

The film used according to the invention can be made of any material which appears to be suitable to a person skilled in the art, for example polyethylene.

The film used according to the invention generally has any thickness which appears to be suitable to a person skilled in the art, for example from 5 to 150 μm.

A jaw band used according to the invention is known per se to those skilled in the art. It generally comprises two circumferential ridges which, depending on the pipe dimensions, carry shape-imparting aluminum jaws. These aluminum jaws are, for example, pipe half shells which on coming together form the complete pipe cross section. Up to 180, for example, individual segments are installed on each circumferential ridge.

The at least one medium pipe is, in step (A) of the process of the invention, arranged within the film tube in such a way that a gap, in the case of one medium pipe being present an annular gap, is formed between the at least one medium pipe and the film tube. Particular preference is given to the one medium pipe being arranged centrally in the, preferably circular, film tube so as to form a concentric annular gap. In the case of more than one medium pipe being present, these pipes are preferably arranged symmetrically in the film tube.

Step (B):

Step (B) of the process of the invention comprises introduction of a polyurethane system comprising at least one isocyanate component (a) and at least one polyol (b) into the gap, preferably into the annular gap.

The introduction as per step (B) of the process of the invention can generally be carried out using any apparatus known to those skilled in the art, for example high-pressure metering machines which are freely available on the market, for example from the companies Hennecke GmbH, Cannon Deutschland GmbH or Krauss Maffei Kunststofftechnik GmbH. According to the invention, it is also possible to use a multiple nozzle bent so as to correspond to the radius of the gap formed for the introduction of the polyurethane system as per step (B) of the process of the invention.

In step (B) of the process of the invention, a polyurethane system having thixotropic properties is introduced. The terms “ thixotropy” and “thixotropic properties” are known per se to those skilled in the art. For the purposes of the invention, thixotropic properties mean that the liquid reaction mixture foams immediately after leaving the mixing head without the actual reaction between polyol and isocyanate components having commenced. This prefoaming, for example comparable with shaving foam, leads to the material being dimensionally stable and remaining at the place of application.

In general, any polyurethane system having thixotropic properties which appears suitable to a person skilled in the art can be used in step (B) of the process of the invention. According to the invention, the polyurethane systems used can intrinsically have the thixotropic properties or the latter are obtained by addition of appropriate additives.

In a preferred embodiment of the process of the invention, at least one thixotrope is added to the polyurethane system before or during step (B).

The present invention therefore preferably provides the process of the invention in which at least one thixotrope is added to the polyurethane system before or during step (B).

Suitable thixotropes are, for example, selected from the group consisting of inorganic thixotropes, for example organomodified sheet silicates, hydrophobic or hydrophilic pyrogenic silicas, organic thixotropes, for example polyol esters, toluenediamide (TDA) and derivatives thereof, liquid thixotropes based on urea-urethanes, for example isophoronediamine (CAS-No. 2855-13-2), 2,2′-dimethyl-4,4′-methylenebis(cyclohexylamine) (CAS-No. 6864-37-5), diethyltoluenediamine (CAS-No. 68479-98-1), triethyleneglycoldiamine (CAS-No. 929-59-9), polyoxypropylenediamine (CAS-No. 9046-10-0), and mixtures thereof.

The present invention therefore preferably provides the process of the invention in which the at least one thixotrope is selected from the group consisting of inorganic thixotropes, for example organomodified sheet silicates, hydrophobic or hydrophilic pyrogenic silicas, organic thixotropes, for example polyol esters, toluenediamide (TDA) and derivatives thereof, liquid thixotropes based on urea-urethanes, for example isophoronediamine (CAS-No. 2855-13-2), 2,2′-dimethyl-4,4′-methylenebis(cyclohexylamine) (CAS-No. 6864-37-5), diethyltoluenediamine (CAS-No. 68479-98-1), triethyleneglycoldiamine (CAS-No. 929-59-9), polyoxypropylenediamine (CAS-No. 9046-10-0), and mixtures thereof.

The at least one thixotrope can, according to the invention, be added to the polyurethane system or to the at least one isocyanate component (a) or to the at least one polyol (b), preferably to the at least one isocyanate component (a) or to the at least one polyol (b). The at least one thixotrope which is preferably present according to the invention is, for example, added in an amount of from 0.1 to 20% by weight, preferably from 0.2 to 10% by weight, particularly preferably from 0.2 to 7% by weight, very particularly preferably from 0.2 to 5% by weight, in each case based on the at least one isocyanate component (a) or the at least one polyol (b).

Polyurethane systems which can be used or are preferably used according to the invention will be described in detail below.

As isocyanate component (a), use is made of the customary aliphatic, cycloaliphatic and in particular aromatic diisocyanates and/or polyisocyanates. Preference is given to using diphenylmethane diisocyanate (MDI) and in particular mixtures of diphenylmethane diisocyanate and polyphenylene-polymethylene polyisocyanates (crude MDI). The isocyanates can also be modified, for example by incorporation of uretdione, carbamate, isocyanurate, carbodiimide, allophanate and in particular urethane groups.

The isocyanate component (a) can also be used in the form of polyisocyanate prepolymers. These prepolymers are known from the prior art. They are prepared in a manner known per se by reacting polyisocyanates (a) as described above, for example at temperatures of about 80° C., with compounds having hydrogen atoms which are reactive toward isocyanates, preferably with polyols, to form polyisocyanate prepolymers. The polyol/polyisocyanate ratio is generally selected so that the NCO content of the prepolymer is from 8 to 25% by weight, preferably from 10 to 22% by weight, particularly preferably from 13 to 20% by weight.

According to the invention, particular preference is given to using crude MDI as isocyanate component (a).

In a preferred embodiment, the isocyanate component (a) is selected so that it has a viscosity of less than 800 mPas, preferably from 100 to 650 mPas, particularly preferably from 120 to 400 mPas, in particular from 180 to 350 mPas, measured in accordance with DIN 53019 at 25° C.

In the polyurethane system used according to the invention, the at least one polyol is preferably a polyol mixture (b) which generally comprises polyols as constituent (b1), and optionally chemical blowing agents as constituent (b2). In general, the polyol mixture (b) comprises physical blowing agents (b3).

The viscosity of the polyol mixture (b) used according to the invention (but without physical blowing agents (b3)) is generally from 200 to 10000 mPas, preferably from 500 to 9500 mPas, particularly preferably from 1000 to 9000 mPas, very particularly preferably from 2500 to 8500 mPas, in particular from 3100 to 8000 mPas, in each case measured in accordance with DIN 53019 at 20° C. In a particularly preferred embodiment, a polyol mixture (b) (but without physical blowing agents (b3)) which has a viscosity of more than 3000 mPas, for example from 3100 to 8000 mPas, in each case measured in accordance with DIN 53019 at 20° C., is used in the process of the invention.

The present invention therefore preferably provides the process of the invention in which a polyol mixture (b) (but without physical blowing agents (b3)) which has a viscosity of more than 3000 mPas, for example from 3100 to 8000 mPas, in each case measured in accordance with DIN 53019 at 20° C., is used as at least one polyol (b).

The polyol mixture (b) generally comprises physical blowing agents (b3). However, the addition of physical blowing agent leads to a significant decrease in the viscosity. It is therefore an important aspect of the invention that the viscosities of the polyol mixture (b) indicated above relate, even in the case of the polyol mixture comprising physical blowing agents, to the viscosity of the polyol mixture (b) without addition of physical blowing agents (b3).

Possible polyols (constituent b1) are generally compounds having at least two groups which are reactive toward isocyanate, i.e. having at least two hydrogen atoms which react with isocyanate groups. Examples thereof are compounds having OH groups, SH groups, NH groups and/or NH2 groups.

As polyols (constituent b1), preference is given to using compounds based on polyesterols or polyetherols. The functionality of the polyetherols and/or polyesterols is generally from 1.9 to 8, preferably from 2.4 to 7, particularly preferably from 2.9 to 6.

The polyols (b1) have a hydroxyl number of generally greater than 100 mg KOH/g, preferably greater than 150 mg KOH/g, particularly preferably greater than 200 mg KOH/g. A suitable upper limit to the hydroxyl number has generally been found to be 1000 mg KOH/g, preferably 800 mg KOH/g, particularly preferably 700 mg KOH/g, very particularly preferably 600 KOH/g. The OH numbers indicated above relate to the totality of the polyols (b1), which does not rule out individual constituents of the mixture having higher or lower values.

Component (b1) preferably comprises polyether polyols which are prepared by known methods, for example from one or more alkylene oxides having from 2 to 4 carbon atoms in the alkylene radical by anionic polymerization using alkali metal hydroxides such as sodium or potassium hydroxide or alkali metal alkoxides such as sodium methoxide, sodium or potassium ethoxide or potassium isopropoxide as catalysts with addition of at least one starter molecule comprising from 2 to 8, preferably from 3 to 8, reactive hydrogen atoms in bound form or by cationic polymerization using Lewis acids such as antimony pentachloride, boron fluoride etherate, etc., or bleaching earth as catalysts.

Suitable alkylene oxides are, for example, tetrahydrofuran, 1,3-propylene oxide, 1,2- or 2,3-butylene oxide, styrene oxide and preferably ethylene oxide and 1,2-propylene oxide. The alkylene oxides can be used individually, alternately in succession or as mixtures.

Possible starter molecules are alcohols such as glycerol, trimethylolpropane (TMP), pentaerythritol, sugar compounds such as sucrose, sorbitol, and also amines such as methylamine, ethylamine, isopropylamine, butylamine, benzylamine, aniline, toluidine, toluenediamine, naphthylamine, ethylenediamine (EDA), diethylenetriamine, 4,4′-methylenedianiline, 1,3-propanediamine, 1,6-hexanediamine, ethanolamine, diethanolamine, triethanolamine and the like.

Further starter molecules which can be used are condensation products of formaldehyde, phenol and diethanolamine or ethanolamine, formaldehyde, alkylphenols and diethanolamine or ethanolamine, formaldehyde, bisphenol A and diethanolamine or ethanolamine, formaldehyde, aniline and diethanolamine or ethanolamine, formaldehyde, cresol and diethanolamine or ethanolamine, formaldehyde, toluidine and diethanolamine or ethanolamine and also formaldehyde, toluenediamine (TDA) and diethanolamine or ethanolamine and the like.

Preference is given to using glycerol, sucrose, sorbitol and EDA as starter molecule.

The polyol mixture can also optionally comprise chemical blowing agents as constituent (b2). As chemical blowing agents, preference is given to water or carboxylic acids, in particular formic acid. The chemical blowing agent is generally used in an amount of from 0.1 to 4% by weight, preferably from 0.2 to 2.0% by weight and particularly preferably from 0.3 to 1.5% by weight, in each case based on the weight of the component (b).

As mentioned above, the polyol mixture (b) generally comprises a physical blowing agent (b3). Physical blowing agents are compounds which are dissolved or emulsified in the starting materials for polyurethane production and vaporize under the conditions of polyurethane formation. These are, for example, hydrocarbons, for example cyclopentane, halogenated hydrocarbons and other compounds such as perfluorinated alkanes, e.g. perfluorohexane, chlorofluorocarbons and also ethers, esters, ketones and/or acetals. These are usually used in an amount of from 1 to 30% by weight, preferably from 2 to 25% by weight, particularly preferably from 3 to 20% by weight, based on the total weight of the component (b).

The present invention therefore preferably provides the process of the invention in which the polyurethane system is foamed by means of pentane, preferably cyclopentane, as physical blowing agent.

In a preferred embodiment, the polyol mixture (b) comprises crosslinkers as constituent (b4).

For the purposes of the present invention, crosslinkers are compounds which have a molecular weight of from 60 to 400 g/mol and have at least 3 hydrogen atoms which are reactive toward isocyanates. An example is glycerol.

The crosslinkers (b4) are generally used in an amount of from 1 to 10% by weight, preferably from 2 to 6% by weight, based on the total weight of the polymer mixture (b) (but without physical blowing agents (b3)).

In a further preferred embodiment, the polyol mixture (b) comprises chain extenders, which serve to increase the crosslinking density, as constituent (b5). For the purposes of the present invention, chain extenders are compounds which have a molecular weight of from 60 to ≦400 g/mol and have 2 hydrogen atoms which are reactive toward isocyanates. Examples are butanediol, diethylene glycol, dipropylene glycol and ethylene glycol.

The chain extenders (b5) are generally used in an amount of from 2 to 20% by weight, preferably from 4 to 15% by weight, based on the total weight of the polyol mixture (b) (but without physical blowing agents (b3)).

The components (b4) and (b5) can be used individually or in combination in the polyol mixture.

The polyurethane foams present as insulating material according to the invention can be obtained by reaction of the polyurethane system according to the invention.

In the reaction, the at least one isocyanate component (a) and the at least one polyol (b), preferably the polyol mixture (b), are generally reacted in such amounts that the isocyanate units of the foam is from 90 to 240, preferably from 90 to 200, particularly preferably from 95 to 180, very particularly preferably from 95 to 160, in particular from 100 to 149.

In a preferred embodiment, components (a) and (b) of the polyurethane system are selected so that the resulting foam has a compressive strength (at a foam density of 60 kg/m³) of greater than 0.2 N/mm², preferably greater than 0.25 N/mm², particularly preferably greater than 0.3 N/mm², measured in accordance with DIN 53421.

In general, the overall injected foam density is more than 50 kg/m′, preferably more than 60 kg/m³, particularly preferably more than 70 kg/m³, very particularly preferably more than 80 kg/m³, in particular more than 100 kg/m³, in the process of the invention. The upper limit to the overall injected foam density is preferably in each case 300 kg/m³. The overall injected foam density is generally understood to be the total amount of liquid polyurethane material introduced based on the total volume of the annular gap for the foam.

The process of the invention can generally be carried out at any compaction which appears suitable to a person skilled in the art. For the purposes of the present invention, compaction is the total fill density of the annular gap divided by the free-foamed core foam density determined on an uncompacted foam body.

The present invention preferably provides the process of the invention in which the reaction is carried out at a compaction of less than 2.0, preferably less than 1.5, particularly preferably less than 1.4 and very particularly preferably less than 1.3, in particular less than 1.2.

The polyurethane system used in step (B) of the process of the invention preferably comprises at least one catalyst. According to the invention, it is generally possible to use all catalysts which appear to be suitable to a person skilled in the art.

Catalysts which are preferably used according to the invention catalyze the blowing reaction, i.e. the reaction of diisocyanate with water. This reaction takes place predominantly before the actual polyurethane chain formation, i.e. the polymerization reaction, and therefore leads to a fast reaction profile of the polyurethane system. Furthermore, catalysts which catalyze the polyurethane gelling reaction or the trimerization reaction of the isocyanate can preferably be used.

Examples of catalysts which can be used according to the invention are selected from the group consisting of organic tin compounds such as tin(II) salts or organic carboxylic acids, for example potassium acetate, potassium formate and/or potassium octoate, basic amine compounds such as secondary aliphatic amines, for example N,N-dimethylaminoethoxyethanol (CAS number 1704-62-7), N,N,N′,N′-tetramethyl-2,2′-oxybis(ethylamine) (CAS number 3033-62-3), imidazoles, amidines, alkanolamines, preferably tertiary amines, for example 2-[[2-(dimethylamino)ethyl]methylamino]ethanol (CAS number 2212-32-0), methylbis(2-dimethylaminoethyl)amine (CAS number 3030-47-5), triethylamine, 1,4-diazabicyclo[2.2.2]octane, dimethylbenzylamine, dimethylcyclohexylamine, (2-hydroxypropyl)trimethylammonium 2-ethylhexanoate (CAS number 62314-22-1), N,N,N-trimethyl-2-hydroxy-1-propaneammonium formate, trimethylhydroxypropylammonium formate, 2-((2-dimethylamino)ethyl)methylamino)ethanol (CAS number 2212-32-0) and/or N,N′,N″-tris(dimethylaminopropyl)hexahydrotriazine (CAS number 15875-13-5), glycine, N-((2-hydroxy-5-nonylphenyl)methyl)-N-methyl monosodium salt (CAS number 56968-08-2) and mixtures thereof.

The catalysts which are preferred according to the invention can be added to the polyurethane system in any way known to those skilled in the art, for example neat or as a solution, for example as an aqueous solution.

Based on the polyol component (b), the at least one catalyst is, according to the invention, added in an amount of from 0.01 to 5% by weight, preferably from 0.5 to 5% by weight, particularly preferably from 1 to 5% by weight, very particularly preferably from 1.5 to 5% by weight, in particular from 2 to 5% by weight.

Additives (b6) can optionally also be added to the polyurethane system used according to the invention. For the purposes of the present invention, additives (b6) are the customary auxiliaries and additives known in the prior art, but without physical blowing agents. Mention may be made by way of example of surface-active substances, foam stabilizers, cell regulators, fillers, dyes, pigments, flame retardants, antistatics, hydrolysis inhibitors and/or fungistatic and bacteriostatic substances. It may be pointed out that the general and preferred viscosity ranges indicated above for the component (b) apply to a polyol mixture (b) including any additives (b6) added (but excluding any physical blowing agent (b3) added).

The present invention therefore preferably provides the process of the invention in which the at least one polyol mixture (b) comprises polyols (b1), optionally chemical blowing agents (b2), physical blowing agents (b3), crosslinkers (b4), chain extenders (b5), catalysts and/or optionally additives (b6).

The present invention therefore provides, in particular, the process of the invention in which from 1 to 25% by weight of flame retardants, based on the total weight of the polyol mixture, is used as additive (b6).

Step (C):

Step (C) of the process of the invention comprises foaming and allowing curing of the polyurethane system.

The foaming and curing is, according to the invention, generally carried out at a component temperature of from 18 to 40° C., preferably from 18 to 35° C., particularly preferably from 22 to 30° C.

The foaming and curing is, according to the invention, generally carried out at a surface temperature of from 15 to 50° C., preferably from 20 to 50° C., particularly preferably from 25 to 45° C.

After step (C) of the process of the invention, an insulated pipe is obtained comprising at least one medium pipe, a film tube and an insulating layer composed of polyurethane foam between at least one medium pipe and the film tube.

The insulating layer generally has a thickness of from 1 to 20 cm, preferably from 3 to 20 cm, particularly preferably from 5 to 20 cm.

In a further preferred embodiment, the insulating layer comprising polyurethane foam has a thermal conductivity of less than 27 mW/mK, preferably less than 26 mW/mK, particularly preferably less than 25 mW/mK, very particularly preferably less than 24 mW/mK, in particular less than 23 mW/mK, in each case measured in accordance with EN ISO 8497.

Step (D):

Step (D) of the process of the invention comprises the application of a layer of at least one material to the film tube in order to form the outer pipe.

After step (C) of the process of the invention at least one medium pipe which is surrounded by an insulating layer of at least one polyurethane foam which is in turn surrounded by the film tube produced in step (A) is obtained. To form the outer pipe composed of at least one material, this is applied in step (D) of the process of the invention. According to the invention, any suitable material can generally be used as outer pipe.

In a further embodiment of the process of the invention, the material from which the outer pipe is formed in step (D) is a thermoplastic polymer.

The present invention therefore preferably provides the process of the invention in which the material from which the outer pipe is formed in step (D) is a thermoplastic polymer, in particular polyethylene.

The application of thermoplastic polymers can, according to the invention, be effected by extrusion. The extrusion of thermoplastic polymers to produce a layer, here the outer pipe, is known per se to those skilled in the art.

The application according to step (D) of the process of the invention is generally carried out at a temperature which appears suitable to a person skilled in the art for extrusion of thermoplastic polymers, for example above the melting temperature of the thermoplastic polymer used. Suitable temperatures are, for example, from 180 to 220° C., preferably from 190 to 230° C. or 180 to 230 ° C., preferably 190 to 220 ° C.

The outer pipe formed in step (D) of the process of the invention generally has a thickness of from 1 to 30 mm. The internal diameter of the outer pipe depends, according to the invention, on the diameter of the film tube and is, for example, from 6 to 90 cm, preferably from 12 to 90 cm, particularly preferably from 19 to 90 cm.

The outer pipe can optionally comprise a plurality of layers which can be brought together during the extrusion process for producing the outer pipe. An example is the introduction of multilayer films between polyurethane foam and outer pipe, with the film comprising at least one metallic layer in order to improve the barrier action. Suitable outer pipes of this type are described in EP-A-960 723. This additional layer which is optionally present is preferably introduced together with the film in step (A). For example, it is possible, according to the invention, to use multilayer films comprising aluminum as diffusion barrier.

According to the invention, all thermoplastic polymers which have properties which are advantageous for a correspondingly insulated pipe are generally suitable. Examples of thermoplastic polymers which can be used according to the invention are selected from the group consisting of polyethylene, polypropylene and mixtures thereof, with preference being given to using polyethylene.

After step (D) of the process of the invention the insulated pipe formed can be treated further by methods known to those skilled in the art, for example by cutting of the continuously produced and thus in principle infinitely long insulated pipe into desired lengths, for example 6, 12 or 16 m.

In a particularly preferred embodiment, the insulated pipe produced according to the invention is an insulated composite outer pipe for district heating networks laid in the ground, which meets the requirements of DIN EN 253:2009.

The present invention also provides an insulated pipe which can be produced by the process of the invention. The details of the insulated pipe produced which had been mentioned with regard to the process of the invention apply analogously. The pipe which has been produced continuously according to the invention displays a particularly uniform density distribution over the entire length and, as a result of this, low lambda values combined with better physical properties. At the same time, the insulated pipe produced according to the invention has a large external diameter of, for example, from 125 to 920 mm and/or a particularly high foam density of, for example, from 50 to 300 kg/m³.

The present invention also provides an apparatus for producing an insulated pipe, which comprises an apparatus for introduction of at least one medium pipe, an apparatus for the introduction of a film for forming a film tube, a jaw band, an apparatus for forming an outer pipe and an apparatus for addition of at least one thixotrope, preferably for carrying out the process of the invention. An apparatus for introduction of at least one thixotrope is, for example, a multicomponent mixing head or introduction via a static mixer into the high-pressure circuit.

According to the invention, the at least one thixotrope, as described above, can be added during or shortly before production of the polyurethane foam. In a second embodiment according to the invention, the at least one thixotrope is mixed into at least one of the precursor compounds for production of the same and brought to the location where the polyurethane foam is produced and mixed there with the further precursor compounds.

The individual apparatuses described are known per se to those skilled in the art. In the case of the apparatus of the invention, preferably for carrying out the process of the invention, these apparatuses known per se have to be arranged according to the invention.

The present invention also provides for the use of the apparatus of the invention for carrying out the process of the invention, in particular for producing the insulated pipe according to the invention.

1. A continuous process for producing an insulated pipe, the continuous process comprising:
providing, in a jaw band, a medium pipe and a film tube formed continuously from a film, wherein the medium pipe is arranged within the film tube, thereby forming a gap between the medium pipe and the film tube,
introducing a polyurethane system comprising an isocyanate component and a polyol into the gap,
foaming and allowing curing of the polyurethane system, and
applying a layer of a material to the film tube, thereby forming the outer pipe,
wherein the insulated pipe comprises the medium pipe, the outer pipe, a layer of a polyurethane between the medium pipe and the outer pipe, and the film tube between the polyurethane and the outer pipe and
the polyurethane system has a thixotropic property.

2. The continuous process of claim 1, wherein a thixotrope is added to the polyurethane system before or during the introducing.

3. The continuous process of claim 2, wherein the thixotrope is at least one selected from the group consisting of an inorganic thixotrope, a hydrophobic or hydrophilic pyrogenic silica, an organic thixotrope, toluenediamide, and a derivative thereof, and a liquid thixotrope based on urea-urethanes, for.

4. The continuous process of claim 1, wherein the material is a thermoplastic polymer.

5. The continuous process of claim 1, wherein the film has a width so that a corresponding film tube having an internal diameter of from 6 to 90 cm, is formed.

6. The continuous process of claim 1, wherein an overall injected foam density is more than 50 kg/m³.

7. An insulated pipe produced by the continuous process of claim 1.

8. An apparatus for producing an insulated pipe, the apparatus comprising:
an apparatus for introducing a medium pipe;
an apparatus for introducing a film for forming a film tube;
a jaw band;
an apparatus for forming an outer pipe; and
an apparatus for adding a thixotrope.

9-10. (canceled)

11. A continuous process for producing an insulated pipe, the continuous process comprising:
producing the insulated pipe with the apparatus of claim 8.

12. An insulated pipe produced by the continuous process of claim 11.

13. The continuous process of claim 3, wherein the inorganic thixotrope is an organomodified sheet silicate.

14. The continuous process of claim 3, wherein the organic thixotrope is a polyol ester.

15. The continuous process of claim 3, wherein the liquid thixotrope based on urea-urethanes is isophoronediamine, 2,2′-dimethyl-4,4′-methylenebis(cyclohexylamine), diethyltoluenediamine, triethyleneglycolamine, polyoxypropylenediamine, or a mixture thereof.

16. The continuous process of claim 5, wherein the internal diameter of the corresponding film tube is from 12 to 90 cm.

17. The continuous process of claim 16, wherein the internal diameter of the corresponding film tube is from 19 to 90 cm.

18. The continuous process of claim 17, wherein the internal diameter of the corresponding film tube is from 35 to 90 cm.

19. The continuous process of claim 6, wherein the overall injected foam density is more than 60 kg/m³.

20. The continuous process of claim 19, wherein the overall injected foam density is more than 70 kg/m³.

21. The continuous process of claim 20, wherein the overall injected foam density is more than 80 kg/m³.

22. The continuous process of claim 21, wherein the overall injected foam density is more than 100 kg/m³.
